(19) United States
(12) Patent Application Publication
(10) Pub. No.: US 2015/0062005 A1
(43) Pub. Date: Mar. 5, 2015

(54) METHOD AND SYSTEM FOR PROVIDING USER INTERACTION WHEN CAPTURING CONTENT IN AN ELECTRONIC DEVICE

(71) Applicant: Samsung Electronics Co., Ltd., Suwon-si (KR)

(72) Inventors: Gandhi Gurunathan RAJENDRAN, Bangalore (IN); Subramanian RAMAKRISHNAN, Bangalore (IN); Rames PALANISAMY, Bangalore (IN); Krishnamraju Murali Venkata MUTYALA, Bangalore (IN); Prakhyath Kumar HEGDE, Udupi Tq and District (IN); Joohyung PARK, Seoul (KR)

(21) Appl. No.: 14/477,508

(22) Filed: Sep. 4, 2014

(30) Foreign Application Priority Data
Sep. 4, 2013 (IN) 3958/CHE/2013

(51) Int. Cl. G06K 9/00; G06F 3/00

(52) U.S. Cl. CPC G06K 9/00033; G06F 3/005
USPC 345/156

(57) ABSTRACT

A method and system for executing an operation in an electronic device using a camera are provided. Each finger action is associated with an operation. Further, the operation is classified as a processing operation that is executed when capturing content, or a post-processing operation that is executed after capturing the content. The method executes the operation based on the fingerprint of the user. The electronic device comprises a fingerprint reader to read the fingerprint of the user and can be present external to a screen of the electronic device or can be integrated within the screen of the electronic device.

### CROSS-REFERENCE TO RELATED APPLICATION(S)

This application claims the benefit under 35 U.S.C. §119(a) of an Indian patent application filed on Sep. 4, 2013 in the Indian Intellectual Property Office and assigned Serial number 3958/CHE/2013, the entire disclosure of which is hereby incorporated by reference.

### TECHNICAL FIELD

The present disclosure relates to user interaction with an electronic device. More particularly, the present disclosure relates to executing an operation based on a fingerprint of a user when capturing content using a camera and with a captured content in the electronic device.

### BACKGROUND

Increasingly, many electronic devices support fingerprint recognition. Fingerprint recognition is used for identifying and authenticating users accessing applications in the electronic device.

In methods of the related art, when a user needs to share or store captured content, the user has to perform many operations to share or store the captured content. For example, an electronic device allows a user to perform various operations on the electronic device such as capturing content using a content capturing application, sharing the captured content from a content capturing application, storing the captured content, browsing the Internet, sending an email, identifying a geographical location using a navigation chart, and so on. A user may zoom in or zoom out while capturing content such as an image or video by using a hardware key or by using a pinch option in touch screen. The user may have to navigate through a multiple number of steps to execute any operation on the electronic device. For example, the user has to navigate through a number of steps for capturing content, storing the captured content, and then sharing the captured content to any social networking sites. Accordingly, there is a need in the art for an electronic device that reduces and simplifies the steps for capturing, storing, and sharing content.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method to execute an operation in an electronic device by receiving an input action from a user's finger when capturing content using a camera, and after capturing the content in an electronic device.

Another aspect of the present disclosure is to provide a method for executing an operation based on a fingerprint in an electronic device having a camera, the method comprising receiving an input action from a user using at least one finger, identifying the at least one finger using at least one fingerprint corresponding to the at least one finger, and executing at least one of a processing operation and a post-processing operation identified by the at least on fingerprint.

Another aspect of the present disclosure is to provide an electronic device for executing an operation based on a fingerprint, the electronic device comprising a camera, a fingerprint reader configured to receive an input action from a user using at least one finger, and a controller configured to identify the at least one finger using at least one fingerprint corresponding to the at least one finger and to execute at least one of a processing operation and a post-processing operation identified by the at least one fingerprint.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an electronic device comprising various modules providing user interaction in capturing content using an input action of a user according to an embodiment of the present disclosure;

FIG. 2A illustrates a user interaction with a fingerprint reader placed external to a screen of the electronic device according to an embodiment of the present disclosure;

FIG. 2B illustrates a user interaction with the fingerprint reader integrated within the screen of the electronic device according to an embodiment of the present disclosure;

FIG. 3 illustrates an example to share the captured content using input actions of the user in an electronic device according to an embodiment of the present disclosure;

FIG. 4 illustrates an example to store the captured content using an input action of the user in the electronic device according to an embodiment of the present disclosure;

FIG. 5 illustrates an example to change parameters associated with captured content using an input action of the user in the electronic device according to an embodiment of the present disclosure;

FIG. 6 illustrates a flow diagram showing a method of executing an operation by the content capturing application in the electronic device according to an embodiment of the present disclosure; and

FIG. 7 illustrates a computing environment for implementing methods to execute operations when capturing content in the electronic device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Embodiments herein achieve a method and system for executing an operation based on a fingerprint in an electronic device using a camera. The method includes receiving an input action from a user using one or more fingers. The method further includes identifying the one or more fingers using at least one fingerprint corresponding to one or more fingers. Furthermore, the method includes executing one or more processing operations or post-processing operations identified by the input action. In an embodiment, each input action performed by each finger is associated with one operation.

In an embodiment, the processing operation is executed when capturing content using the camera. For example, the processing operation may include changing parameters associated with the captured content, setting a zoom level for capturing content, setting image filters, setting a flash, setting an International Organization for Standardization (ISO) setting, setting a resolution, setting a timer, setting High-Dynamic-Range (HDR), or the like.

In an embodiment, the post-processing operation is executed after capturing the content using the camera. For example, the post-processing operations may include storing the captured content to a secured location, sharing the captured content to a Social Networking Site (SNS), transferring the captured content to another device, sending the captured content through an email, sending the captured content to one or more contacts, or the like.

Further, the method authenticates one or more input actions of the user before executing processing operations or post-processing operations after identifying one or more fingerprints of the user in the electronic device.

In an embodiment, the registered user has registered his/her fingerprints on the electronic device. The method extracts the fingerprints from one or more finger actions.

In another embodiment, the terms input action and finger action are used interchangeably.

In an embodiment, the finger actions of the user can be a swipe, a touch on a touch screen, or the like performed by the registered user. In an embodiment, the user interacts with the content to be captured or captured content using the finger actions. For example, the finger actions may include performing a left swipe, a right swipe, a swipe upwards, a swipe downwards, or the like on the fingerprint reader in the electronic device. These finger actions are performed based on the orientation of the fingerprint sensor in the fingerprint reader. These actions are associated with operations. For example, by performing a swipe upwards, the captured content can be shared with another user.

In an embodiment, the fingerprint reader can be external to a screen of the electronic device. For example, a user performs one or more actions in an external fingerprint reader.

In another embodiment, the fingerprint reader can be integrated within the screen of the electronic device. For example, the user performs one or more actions using his/her fingers in the fingerprint reader integrated within the screen of the electronic device.

In yet another embodiment, the fingerprint reader can be external to the electronic device and connected through a wired or wireless interface. For example, the wired interface can be a Universal Serial Bus (USB) interface. For example, the wireless interface includes but is not limited to any short range communication such as Bluetooth, Wi-Fi, or Near Field Communication (NFC).

In an embodiment, an electronic device includes but is not limited to a mobile phone, a laptop, a tablet, a personal computer, a digital media player, an electronic watch, or any other electronic device with a fingerprint recognition module that is capable of identifying one or more input actions performed by a registered user and executing an operation on the electronic device based on the identified one or more input actions.

Further, the electronic device may be configured to register and store one or more user finger actions based on one or more fingerprints of the user. Still further, the electronic device may comprise a fingerprint recognition module to authenticate one or more input actions performed by the registered user.

In an embodiment, the method includes analyzing finger action attributes before executing operations on the electronic device. The finger action attributes include, but are not limited to, the positioning of the fingerprint reader (external to the screen of the electronic device or integrated with the screen of the electronic device), orientation of the finger action, angular placement of the finger action, direction of motion of the finger action, and the like. For example, the method identifies the direction of motion of the finger action in an upward direction with the swipe gesture, and an operation is executed for the identified finger action.

In an embodiment, the term “captured content” (and variations thereof) refers to an image or a video captured using a content capture application in the electronic device.

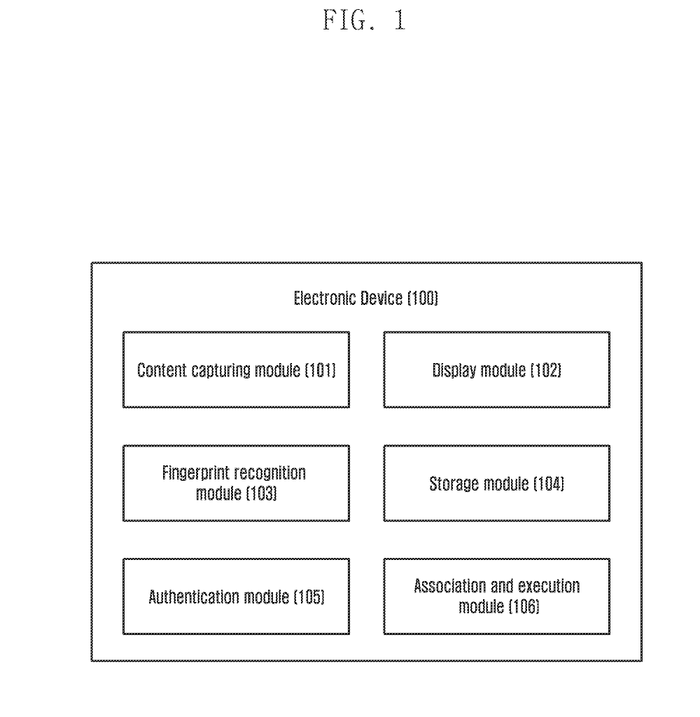

FIG. 1 illustrates a device comprising various modules to provide user interaction in capturing content using an input action of a user according an embodiment of the present disclosure.

Referring to FIG. 1, the electronic device 100 comprises a content capturing module 101, a display module 102, a fingerprint recognition module 103, a storage module 104, an authentication module 105, and an association and execution module 106.

The content capturing module 101 is configured to capture the content displayed in front of the electronic device 100. For example, the content capturing module 101 can be a camera module which is invoked using a camera application in the electronic device 100.

The display module 102 is configured to display the captured content on the electronic device 100. Further, the display module 101 allows the user to provide finger actions of the user as inputs for registering the user fingerprints on the electronic device 100. The electronic device 100 can support the display module 101 in different forms such as a Graphical User Interface (GUI), a browser, a touch screen interface, and the like. As the user provides finger actions as input to the display module 102, the fingerprint recognition module 103 recognizes the fingerprint associated with the finger action of the user and stores the fingerprint of the user in a storage module 104.

In an embodiment, the fingerprint recognition module 102 is configured to recognize the fingerprint of the user when the user places his/her finger on a fingerprint reader and identifies the direction of movement of the fingerprint of the user.

The storage module 104 is configured to store the registered fingerprints of the user and includes, but is not limited to, a memory device, a hard disk, a Random Access Memory (RAM), a Read Only Memory (ROM), or the like.

The authentication module 105 is configured to authenticate the fingerprint of the user by matching the fingerprint with the registered fingerprint of the user that is stored in the storage module 104. Further, based on the matching criteria, the authentication module 105 confirms that the user is the registered user for the electronic device 100.

The association and execution module 106 is configured to associate every identified finger action of the user with a specific operation to be performed on the electronic device 100 based on the fingerprint of the user. Further, the association and execution module 106 is configured to execute the operation identified by the fingerprint of the user on the electronic device 100.

In an embodiment, one or more operations to be executed require authentication of the finger actions of the user by the authentication module 105 before the association and execution module 106 executes an identified operation on the electronic device 100. After identifying the operation for one or more finger actions, the association and execution module 106 is configured to execute the identified operation on the electronic device 100.

In an embodiment, the identified operation for the finger action of the registered user includes a processing operation or a post-processing operation.

In an embodiment, the capturing content parameters include but are not limited to zoom, brightness, color, compression, or the like.

In an embodiment, the identified operation information can be stored in a memory such as a database or in any other storage location of the electronic device 100 for associating the operation with the finger actions of the registered user.

In an embodiment, the fingerprint reader may be placed external to the screen or integrated within the screen of the electronic device 100 to recognize one or more finger actions of the user.

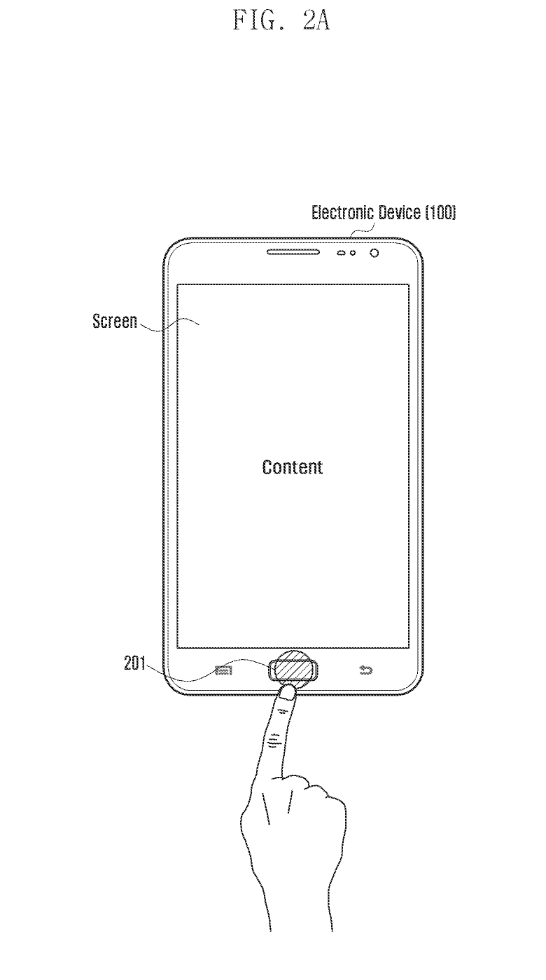

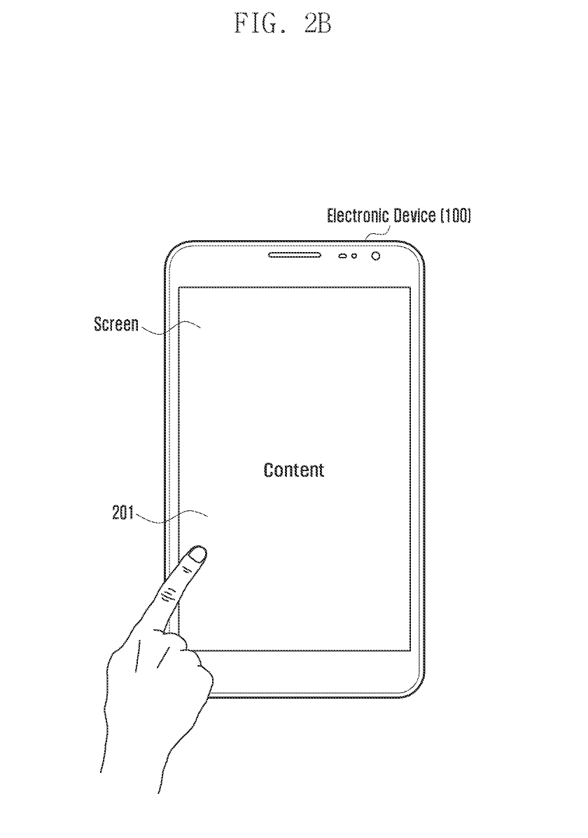

FIG. 2A illustrates a user interaction with a fingerprint reader placed external to a screen of the electronic device, and FIG. 2B illustrates a user interaction with the fingerprint reader integrated within the screen of the electronic device, according to embodiments of the present disclosure.

Referring to FIG. 2A, the electronic device 100 allows the registered user to perform finger actions on the fingerprint reader 201 that is placed external to the screen of the electronic device 100. Referring to FIG. 2B, the electronic device 100 allows the registered user to perform finger actions on the fingerprint reader 201 integrated within the screen of the electronic device 100. Further, each of the finger actions performed on the fingerprint reader 201 is associated with one or more operations. Further, the association and execution module 106 is configured to execute an identified operation on the electronic device 100 based on the finger action performed on the fingerprint reader 201.

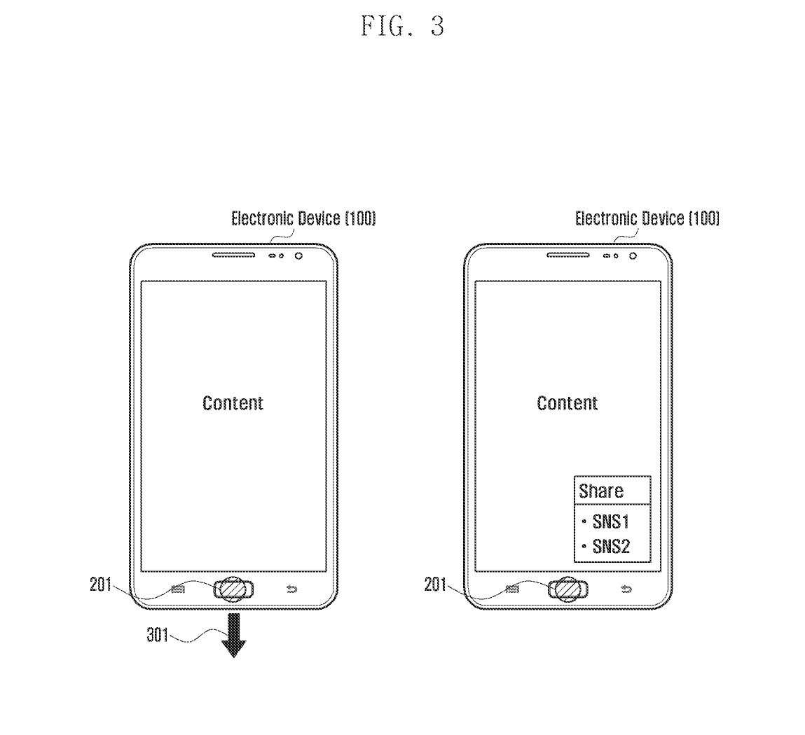

FIG. 3 illustrates an example of sharing the captured content using the input actions of the user in the electronic device 100 according to an embodiment of the present disclosure.

Referring to FIG. 3, the electronic device 100 allows the registered user to perform the finger actions. Further, the fingerprint recognition module 103 is configured to identify the finger actions of the user and the direction of motion of the finger action on the electronic device 100. Further, the association and execution module 106 is configured to execute the identified operation for the finger actions performed on the electronic device 100. For example, when the user performs a downwards thumb swipe 301 on the fingerprint reader 201, the authentication module 105 is configured to authenticate the finger action related to the downwards swipe of the registered user. Further, the association and execution module 106 is configured to execute the post-processing operation of sharing the captured content with one or more Social Networking Services (SNS 1, SNS 2) from the electronic device 100. Further, the operation can be extended to execute the post-processing operation of sending the captured content to one or more contacts through an e-mail.

In an embodiment, a location for sharing the captured content from the electronic device 100 can be specified in a configuration file and included in the association and execution module 106.

Although FIG. 3 is explained in the context of an external fingerprint reader, it is understood by those of ordinary skill in the art that sharing the captured content is also possible when the fingerprint reader is integrated within the screen of the electronic device 100 to recognize one or more finger actions of the user.

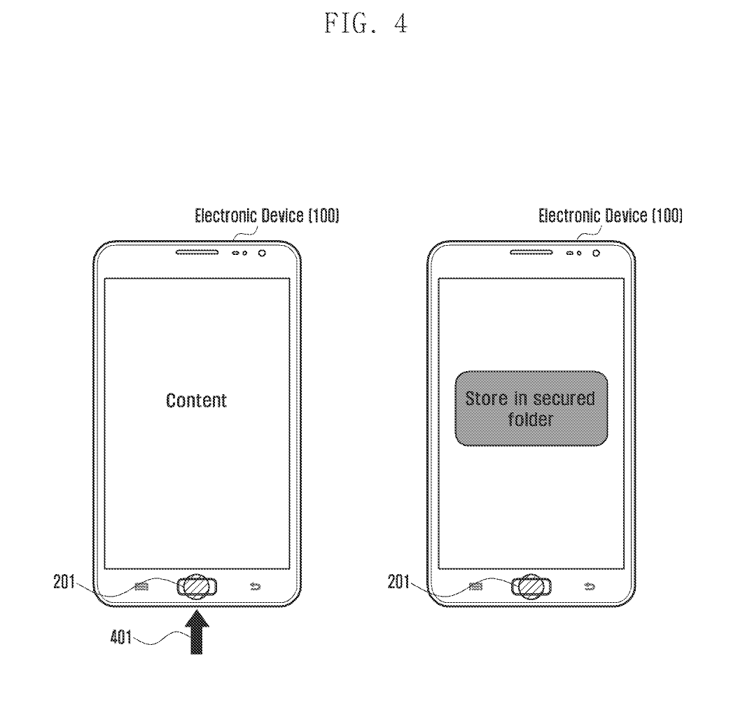

FIG. 4 illustrates an example storing the captured content using the input action of the user in the electronic device according to an embodiment of the present disclosure.

Referring to FIG. 4, the electronic device 100 allows the registered user to perform a finger action on the fingerprint reader 201. Further, the fingerprint recognition module 103 is configured to identify the fingerprint of the registered user and the direction of motion of the finger action on the device 100. Further, the association and execution module 106 is configured to associate and execute the identified operation for the finger action performed on the electronic device 100. For example, when the user performs an upwards thumb swipe 401 on the fingerprint reader 201, the authentication module 105 is configured to authenticate the finger action related to the upwards swipe of the registered user. Further, the association and execution module 106 is configured to store the captured content on one or more secured locations accessible by the electronic device 100. Further, the operation can be extended to execute the post-processing operation of providing access to secured location.

In an embodiment, the secured location for storing the captured content includes but is not limited to a secured folder available in the electronic device 100, a cloud storage location configured for the electronic device 100, a secured website configured for the electronic device 100, or the like.

In an embodiment, the secured location for storing the captured content from the electronic device 100 can be specified in a configuration file and included in the association and execution module 105.

Although FIG. 4 is explained in the context of an external fingerprint reader, it is understood by those of ordinary skill in the art that storing the captured content is also possible when the fingerprint reader is integrated within the screen of the electronic device 100 to recognize one or more finger actions of the user.

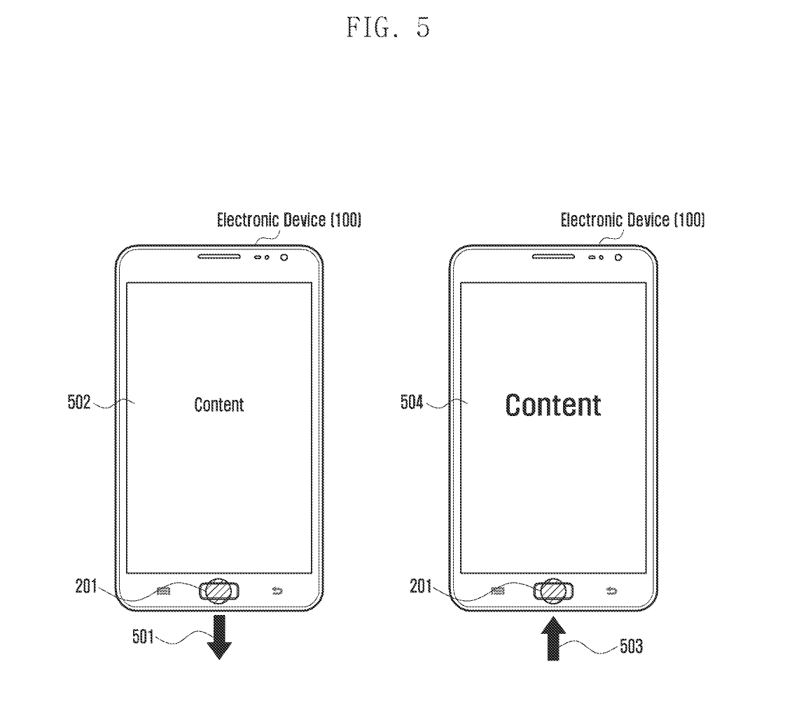

FIG. 5 illustrates an example of changing parameters associated with the capturing of content using the input action of the user in the electronic device according to an embodiment of the present disclosure.

Referring to FIG. 5, the electronic device 100 allows the registered user to perform a finger action. Further, the fingerprint recognition module 102 is configured to identify the finger action of the registered user and the direction of motion of the finger action on the electronic device 100. Further, the association and execution module 106 is configured to associate and execute the identified operation for the finger action performed on the electronic device 100. For example, when the registered user performs a downwards index finger swipe 501 on the fingerprint reader 201, the authentication module 105 is configured to authenticate the finger action related to the downward direction of the registered user. Further, the association and execution module 106 is configured to perform a zoom-in 502 of the captured content on the electronic device 100. Further, the Display module 102 displays the zoomed-in content 502 on the electronic device 100. As another example, when the registered user performs an upwards index finger swipe 503 on the fingerprint reader 201, the authentication module 105 is configured to authenticate the finger action of the registered user. Further, the association and execution module 105 is configured to perform a zoom-out 504 the captured content on the electronic device 100. Further, the display module 101 is configured to display the zoomed-out content 504 on the electronic device 100.

Although FIG. 5 is explained in the context of an external fingerprint reader, it is understood by those of ordinary skill in the art that changing parameters while capturing content is also possible when the fingerprint reader is integrated within the screen of the electronic device 100 to recognize one or more finger actions of the user.

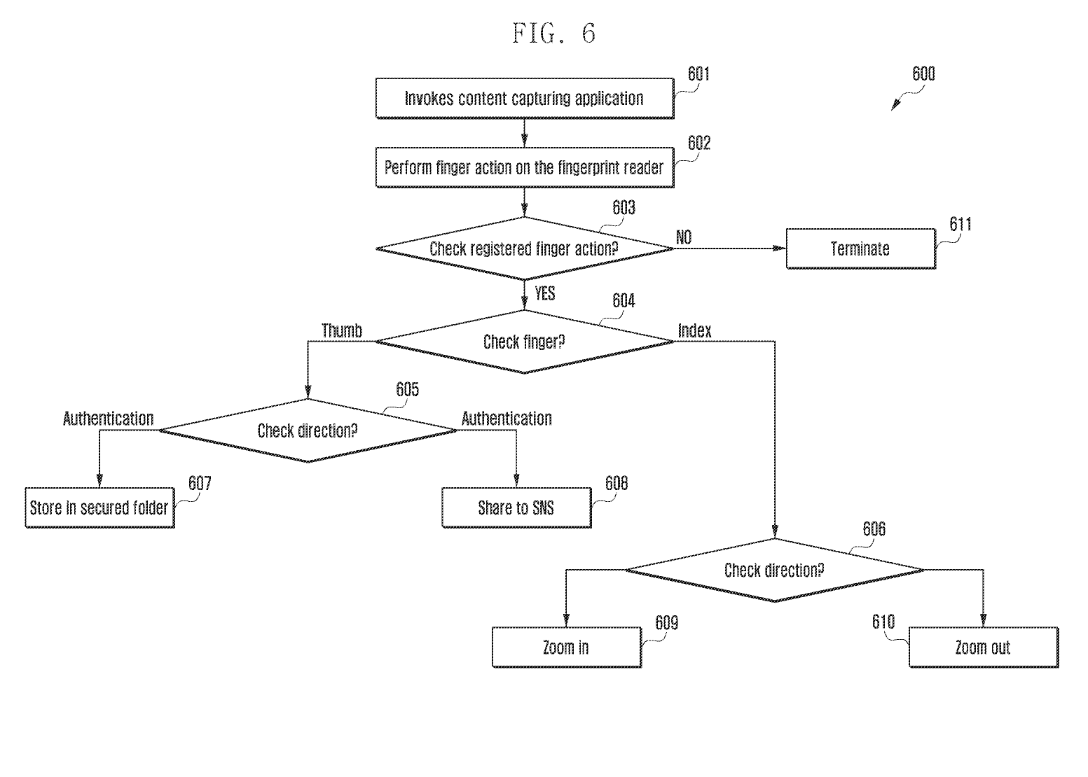

FIG. 6 illustrates a flow diagram explaining the method of executing an operation in the content capturing application in the electronic device according to an embodiment of the present disclosure.

Referring to FIG. 6 and flow diagram 600, initially the user invokes, in operation 601, the content capturing application on the electronic device 100. The user performs, in operation 602, a finger action on the fingerprint reader 201 and the fingerprint recognition module 103 is configured to identify the finger action performed on the electronic device 100.

In an embodiment, the user performs finger actions in a fingerprint reader 201 placed external to the screen of the electronic device 100.

In an embodiment, the user performs finger actions in a fingerprint reader 201 integrated within the screen of the electronic device 100.

Further, the fingerprint recognition module 103 checks, in operation 603, if the finger action of the user matches with a finger action stored in the storage module 104. Further, the fingerprint recognition module 103 is configured to determine, in operation 604, the finger of the registered user that performs the finger action on the fingerprint reader 201. If the method identifies the finger as a thumb finger then the method further checks, in operation 605, the direction of the of the finger and the association, and execution module 106 is configured to store, in operation 607, captured content in a secured folder and also share, in operation 608, the captured content to one or more SNS. Further, the authentication module 105 is configured to authenticate the finger action performed using the thumb before storing and sharing the captured content from the electronic device 100.

If the method identifies the finger as index finger, then the method further checks, in operation 606, the direction of the finger swiped in the fingerprint reader 201. The association and execution module 106 is configured to zoom in, in operation 609, the captured content and also zoom out, in operation 610, the captured content.

Further, if the fingerprint recognition module 103 did not find, in operation 603, a matching finger action of the user stored in the storage module 104, then the method terminates the process in operation 611. The various actions in the flow diagram 600 may be performed in the order presented, in a different order, or simultaneously. Further, in some embodiments, some actions listed in FIG. 6 may be omitted.

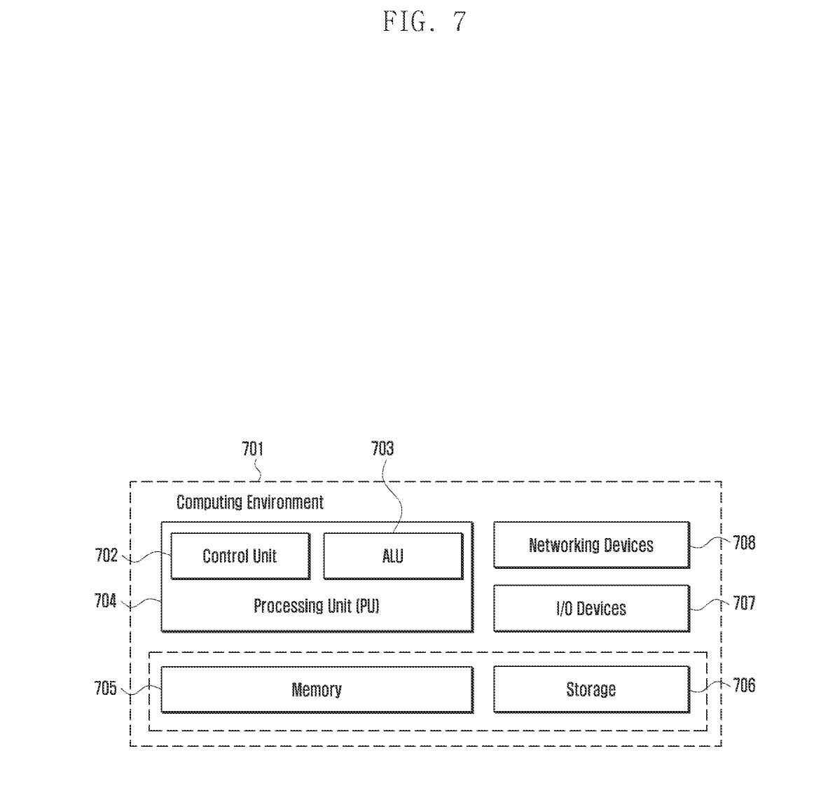

FIG. 7 illustrates a computing environment implementing a method to execute an operation when capturing content using the content capture application in the electronic device according to an embodiment of the present disclosure.

Referring to FIG. 7, the computing environment 701 comprises at least one processing unit 704 that is equipped with a control unit 702 and an Arithmetic Logic Unit (ALU) 703, a memory 705, a storage unit 706, plurality of networking devices 708 and a plurality Input Output (I/O) devices 707. The processing unit 704 is responsible for processing the instructions of the algorithm. The processing unit 704 receives commands from the control unit in order to perform its processing. Further, any logical and arithmetic operations involved in the execution of the instructions are computed with the help of the ALU 703.

The computing environment 701 can be composed of multiple homogeneous and/or heterogeneous cores, multiple CPUs of different kinds, special media and other accelerators. The processing unit 704 is responsible for processing the instructions of the algorithm. Further, the plurality of processing units 704 may be located on a single chip or over multiple chips.

The algorithm comprising of instructions and codes required for the implementation are stored in either the memory unit 705 or the storage 706 or both. At the time of execution, the instructions may be fetched from the corresponding memory 705 and/or storage 706, and executed by the processing unit 704.

In case of any hardware implementations various networking devices 708 or external I/O devices 707 may be connected to the computing environment to support the implementation through the networking unit and the I/O device unit.

The embodiments disclosed herein can be implemented through at least one software program running on at least one hardware device and performing network management functions to control the elements. The elements shown in FIGS. 1, 2, 3, 4, 6 and 7 include blocks which can be at least one of a hardware device, or a combination of hardware device and software module.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for executing an operation based on a fingerprint in an electronic device having a camera, the method comprising:
receiving an input action from a user using at least one finger;
identifying the at least one finger using at least one fingerprint corresponding to the at least one finger; and
executing at least one of a processing operation and a post-processing operation identified by the at least on fingerprint.

2. The method of claim 1, wherein the processing operation is executed when capturing at least one content using the camera.

3. The method claim 1, wherein the post-processing operation is executed after capturing at least one content using the camera.

4. The method claim 1, wherein the input action is received by a fingerprint reader external to a screen of the electronic device.

5. The method claim 1, wherein the input action is received by a fingerprint reader integrated within a screen of the electronic device.

6. The method of claim 1, further comprising identifying a direction of the input action and executing at least one of the processing operation and the post-processing operation identified by the at least on fingerprint and the direction.

7. An electronic device for executing an operation based on a fingerprint, the electronic device comprising:
a camera;
a fingerprint reader configured to receive an input action from a user using at least one finger; and
a controller configured to identify the at least one finger using at least one fingerprint corresponding to the at least one finger and to execute at least one of a processing operation and a post-processing operation identified by the at least one fingerprint.

8. The electronic device of claim 7, wherein the controller is further configured to execute the processing operation when capturing at least one content using the camera.

9. The electronic device of claim 7, wherein the controller is further configured to execute the post-processing operation after capturing the at least one content using the camera.

10. The electronic device of claim 7, wherein the fingerprint reader is external to a screen of the electronic device.

11. The electronic device of claim 7, wherein the fingerprint reader is integrated within the screen of the electronic device.

12. The electronic device of claim 7, wherein the controller is further configured to identify a direction of the input action, and to execute at least one of the processing operation and the post-processing operation identified by the at least one fingerprint and the direction.
